(19) United States
(12) Patent Application Publication
(10) Pub. No.: US 2021/0004843 A1
(43) Pub. Date: Jan. 7, 2021

(54) METHOD AND SYSTEM FOR ECONOMIC AGGREGATE ANALYSIS BASE ON EMPLOYMENT FUNCTION

(71) Applicant: Erdan WANG, Dalian (CN)

(72) Inventors: Erdan WANG, Dalian (CN); Weiwei WANG, Dalian (CN)

(21) Appl. No.: 16/699,542

(22) Filed: Nov. 29, 2019

Related U.S. Application Data
(63) Continuation of application No. PCT/CN2018/085771, filed on May 7, 2018.

(30) Foreign Application Priority Data
Jun. 1, 2017 (CN) 201710413359.5

(51) Int. Cl. G06Q 30/02; G06Q 50/26; G06F 17/11; G06Q 10/06; G06Q 10/04

(52) U.S. Cl. CPC G06Q 30/0201; G06Q 50/26; G06Q 10/04; G06Q 10/063; G06F 17/11

(57) ABSTRACT

The present invention discloses a method and system for economic aggregate analysis based on employment function, comprising steps of: using the variable measured in a real wage-unit as a measuring unit; constructing a simplified model of employment function from the employment multiplier equation according to the Keynes's employment function; obtaining a theoretical mode of employment function from the short-term determining equation of employment multiplier; obtaining a more general form of employment function from the general form of the determining equation of employment multiplier; analyzing the short-term economic change by using the general model of employment function. The present invention can provide a policy basis for governments to timely protect against and response to economic crisis, and can provide an effective technical support for production decision-making of various industries and organizations.

### TECHNICAL FIELD

The present invention relates to a method and system for economic aggregate analysis based on employment function, involving patent classification number G06 computing; calculating; counting G06Q data processing systems or methods specially adapted for administrative, commercial, financial, managerial, supervisory or forecasting purposes; G06Q10/00 administration of processing systems or methods specially adapted for administrative, commercial, financial, managerial, supervisory or forecasting purposes, not included in other classes; and management G06Q10/04 forecasting or optimization, e.g., linear planning, “traveling salesman problems” or “cutting stock problems”.

### BACKGROUND OF THE PRESENT INVENTION

Keynes summarized the principle of effective demand to eight elementary propositions which may be generally expressed as follows. First, under given technologies, resources and costs in the short term, the quantity of employment in equilibrium depends on the effective demand. Then, the effective demand is the sum of the consumption demand and the investment demand when the aggregate supply is equal to the aggregate demand. Therefore, the quantity of employment in equilibrium depends on 1) the aggregate supply function Φ, (2) the propensity to consume χ, and (3) the volume of investment D₂. This is the essence of the General Theory of Employment. Then, generally, the equilibrium employment in practice is less than the full employment. Finally, when the income of a country increases, the propensity to consume usually may decrease. If the volume of investment does not increase correspondingly, the propensity to consume and the new volume of investment may lead to insufficiency of effective demand, causing unemployment in this country. Keynes indicated “the relationship between the effective demand and the employment measured in the wage-unit by an employment function”. If it is assumed that “D_{wr} is a unique function of the total effective demand Dᵣ, the employment function is given by Nᵣ=Fᵣ(D_{w}). That is to say, Nᵣ men will be employed in industry r when the effective demand is D_{w}”.

At present, the aggregate supply model in the mainstream macroeconomic theory uses the production function in the neoclassical growth theory, Y=AF(K,N), i.e., the assumption that labor (N) and capital (K) are the only important input and the output (Y) depends on the input and the technical level (A). On the other hand, by this theory, the Keynes's aggregate demand model is expressed as AD=C+I+G+NX. That is, the aggregate demand (AD) is the sum of consumption (C), investment (I), government (G) and net export (NX). When the output of production is equal to the demand, the output is in an equilibrium state, i.e., Y=AD=C+I+G+NX.

It is thus clear that the mainstream macroeconomic model is obviously different from the Keynes's employment function. The mainstream macroeconomic model “ignores” the key variable that is employment associated with the aggregate supply function and the aggregate demand function, which may become a fatal flaw in the macroeconomic model. The macroeconomic model argues that, output is not always produced when existing resources are fully utilized, but “output fluctuates around the trend level” under normal circumstances. This is obviously different from the observed economic reality. The macroeconomic model assumes that, when the product market reaches the potential output, the labor market is in full employment. In fact, no quantitative relationship has been established between potential output and full employment, so it is difficult to accurately calculate the potential output.

### SUMMARY OF THE PRESENT INVENTION

In view of those problems, a technical problem to be solved by the present invention is to provide a method and system for economic aggregate analysis based on employment function, which can not only accurately analyze the direction and magnitude of the changes in the economy in the short term to provide a policy basis for governments to timely protect against and response to economic crisis, and can also provide an effective technical support for economic analysis, economic forecasting and production decision-making of various industries and organizations.

The technical solution of the present invention is a method and system for economic aggregate analysis based on employment function, including the following.

### Determination of Measurement Units of Economic Aggregates

Keynes “made use of only two fundamental units of quantity, namely, quantities of money-value and quantities of employment” in the analysis of economic aggregates. Keynes chose to measure the total employment of a country by use of its gross wage. “We shall call the unit in which the quantity of employment is measured as the labor-unit; and the money-wage of a labor-unit is called the wage-unit. Thus, if E is the wages (and salaries), W is the wage-unit, and N is the quantity of employment; where E=N·W.”

### Nominal Wage-Unit and Real Wage-Unit

Let W represent the nominal average wage (nominal wage-unit); P represent the consumer price index; w̅ represent the real average wage (real wage-unit); where w̅=W/P.

### Employment Measured in the Real Wage-Unit

At the point in time t, employment measured in the real wage-unit is defined as:

Nₜ^{w}=Nₜ·W̅ₜ (1)

The equation shows that, at each point in time t, the employment measured in the real wage-unit Nₜ^{w} is equal to the product of employment Nₜ and the real average wage W̅ₜ at the point in time, and equal to the real gross wage of a country.

### Employment Multiplier of Effective Demand

According to the basic idea of Keynes's principle of effective demand and the concept of the elasticity of employment and also to the employment multiplier of investment proposed by Kahn, we propose a concept of employment multiplier of effective demand to measure the relationship between the effective demand and the change in employment.

At the point in time t, it is defined that the employment multiplier of effective demand kₜ is equal to the ratio of the change in employment measured in the real wage-unit ΔNₜ^{w} to the real effective demand Yₜ^{d}, i.e.:

kₜ=ΔNₜ^{w}/Yₜ^{d} (2)

The employment multiplier of effective demand may be abbreviated as employment multiplier.

### Simplified Model of Employment Function

A simplified model of employment function may be constructed from the equation (2) according to the Keynes's model Nᵣ=Fᵣ(D_{w}):

ΔNₜ^{w}=kₜYₜ^{d} (3)

where ΔNₜ^{w} is the change in employment, kₜ is the employment multiplier, and Yₜ^{d} is the real effective demand.

The change in employment may be described by the simplified model of employment function. The equation (3) shows that the change in employment depends on not only the effective demand but also whether the numerical value of employment multiplier is positive or negative.

### Fundamental Characters of the Simplified Model of Employment Function

First, the simplified model of employment function describes the quantitative relationship between the employment multiplier, the effective demand and the change in employment. The change in employment ΔNₜ^{w} is positively correlated to the effective demand Yₜ^{d} and the employment multiplier kₜ.

Then, the employment multiplier may be positive, or zero, or even negative. It means that the employment multiplier affects not only the employment but also the direction of change in employment.

1) When kₜ>0, ΔNₜ^{w}>0, indicating that the increase in effective demand cannot ensure the increase in employment in a same proportion, and the quantity of employment increases as the effective demand increases only when the employment multiplier is positive.

2) When kₜ=0, ΔNₜ^{w}=0, indicating that the quantity of employment does not change regardless of whether or not the effective demand increases when the employment multiplier is zero.

3) When kₜ<0, ΔNₜ^{w}<0, indicating that the quantity of employment decreases even if the effective demand increases when the employment multiplier is negative.

### Short-Term Determining Equation of Employment Multiplier

In the short term, on the assumption that the employment multiplier of consumption and the employment multiplier of investment do not change, the short-term determining equation of employment multiplier may be given by the following model:

kₜ=cₜχₜ+bₜδₜ (4)

where kₜ represents the employment multiplier of effective demand, cₜ represents the employment multiplier of consumption, χₜ represents the propensity to consume, bₜ represents the employment multiplier of investment, and δₜ represents the investment rate. 0<χₜ<1, 0<δₜ<1.

The equation (4) shows that, in the short term, on the assumption that both cₜ and bₜ are constants, the employment multiplier depends on the change in structure between the propensity to consume and the investment rate.

### Theory Model of Employment Function

By substituting (4) into (3), a model of the relationship among the propensity to consume, the investment rate, the effective demand and the change in employment may be obtained, which is called the theory model of employment function.

ΔNₜ^{w}=(cₜχₜ+bₜδₜ)Yₜ^{d} (5)

The equation (5) shows that, in the short term, on the assumption that both cₜ and bₜ are constants, the change in employment depends on not only the effective demand but also the relationship between the propensity to consume and the investment rate.

### Description of the Theory Model of Employment Function

It is found, by comparison of the theory model of employment function and the Keynes's model, that there is no essential difference between the two models except that their independent variables are slightly different. There are three independent variables for both models. The independent variables of the Keynes's model are the propensity to consume χ, the volume of investment D₂ and the aggregate supply function Φ; and the independent variables of the theory model of employment function are the propensity to consume χ, the investment rate δₜ and the effective demand Yₜ^{d}. First, with regard to the impact on employment by investment, the use of the volume of investment as an independent variable or the investment as an independent variable produces no essential difference. Then, when the supply and the demand in the market are in equilibrium, the aggregate supply is equal to the effective demand. Therefore, they have the same impact on employment.

### General Form of the Determining Equation of Employment Multiplier

In the short term, on the assumption that both the employment multiplier of consumption cₜ and the investment rate bₜ are constants, the relationship among the propensity to consume, the employment multiplier of investment and the employment multiplier of effective demand may be given by the following model.

kₜ=cₜχₜ+dₜkₜⁱ (6)

where kₜ represents the employment multiplier of effective demand, cₜ represents the employment multiplier of consumption, χₜ represents the propensity to consume, dₜ represents the investment rate, and kₜⁱ represents the employment multiplier of investment. 0<χₜ<1.

The equation (6) shows that, in the short term, on the assumption that both cₜ and dₜ are constants, the change in employment multiplier depends on the relationship between the propensity to consume and the employment multiplier of investment.

### General Model of Employment Function

By substituting (6) into (3), a more general form of employment function may be obtained. In the short-term analysis, the employment function has more practical value. On the assumption that both cₜ and dₜ are constants, the relationship among the propensity to consume, the employment multiplier of investment, the effective demand and the change in employment may be given by the following model.

ΔNₜ^{w}=(cₜχₜ+dₜkₜⁱ)Yₜ^{d} (7)

Usually, the investment demand changes as the effective demand changes. In the short term, the magnitude of change in investment rate is lower than the magnitude of change in employment multiplier of investment. It is assumed that the investment rate is a relatively stable factor, the change in employment multiplier mainly depends on the change in relationship between the propensity to consume and the employment multiplier of investment.

The equation (7) shows that, in the short term, the change in effective demands affects only the quantity of employment; and, the change in relationship between the propensity to consume and the employment multiplier of investment affects not only the quantity of employment but also the direction of change in employment.

### Fundamental Characters of the General Model of Employment Function

First: Relationship between the Effective Demand and the Equilibrium Employment

The effective demand is positively correlated to the quantity of employment. However, the impact on the quantity of employment by the change in effective demand depends, to some extent, on the relative change in the propensity to consume and the employment multiplier of investment.

Second: Relationship between the Propensity to Consume and the Equilibrium Employment

The propensity to consume is positively correlated to the quantity of employment. On the assumption that the employment multiplier of investment does not change, the change in propensity to consume leads to the change in employment in a same direction.

Third: Relationship between the Employment Multiplier of Investment and the Equilibrium Employment

The employment multiplier of investment is positively correlated to the quantity of employment. On the assumption that the propensity to consume does not change, the change in employment multiplier of investment leads to the change in employment in a same direction.

Fourth, the relationship between the propensity to consume χₜ and the employment multiplier of investment kₜⁱ affects not only the quantity of employment but also the direction of change in employment.

1) When (cₜχₜ+dₜkₜⁱ)>0, ΔNₜ^{w}>0, indicating that only when kₜⁱ>−(cₜ/dₜ)χₜ, then the employment multiplier is positive, the quantity of employment increases as the effective demand increases.

2) When (cₜχₜ+dₜkₜⁱ)=0, ΔNₜ^{w}=0, indicating that if kₜⁱ=−(cₜ/dₜ)χₜ, then the employment multiplier is zero, the quantity of employment does not change regardless of whether or not the effective demand increases.

3) When (cₜχₜ+dₜkₜⁱ)<0, ΔNₜ^{w}=0, indicating that if kₜⁱ=−(cₜ/dₜ)χₜ, then the employment multiplier is negative, the quantity of employment decreases even if the effective demand increases.

Fifth, the premise for entrepreneurs to increase their investment is to expect the effective demand to increase, so the expansion of investment does offer the possibility of the increase in effective demand, which is the principal means to solve the insufficiency of effective demand in various countries at present. On the other hand, the change in the relationship between the propensity to consume and the employment multiplier of investment may lead to the insufficiency of effective demand in the society. It is important to note that, if the employment multiplier of investment is negative, the expansion of investment will cause inhibition to employment.

### The Propensity to Consume and the Equilibrium Employment

According to the equation (7), if the propensity to consume approaches 1, then ΔNₜ^{w}≈cₜYₜ^{d}, the impact on the equilibrium employment by investment factors can be ignored. In the short term, on the assumption that the employment multiplier of consumption cₜ is a constant, the equilibrium employment depends on the effective demand. In this case, the employment may be increased by increasing the effective demand in a country. However, the assumption condition for this causal relationship is usually ignored by economists. On the assumption that the propensity to consume approaches 1, the employment changes in a same proportion as the effective demand changes.

### The marginal Propensity to Consume and the Change in Employment

The impact on employment by the change in propensity to consume has to be analyzed together with the impact on employment by the change in volume of investment. In the long term, the equilibrium employment first depends on the propensity to consume; and in the short term, the marginal propensity to consume is an important factor that impacts the change in employment, and the quantity of employment usually increases as the propensity to consume increases. Since the marginal propensity to consume decreases progressively, it is difficult to maintain the increase in employment in the long term by increasing the effective demand by the continuous expansion of investment. The increase in employment can be maintained only by the continuous increase in employment multiplier of investment.

### The Employment Multiplier of Investment and the Change in Employment

Usually, the magnitude of the change in propensity to consume is lower than the magnitude of the change in employment multiplier of investment. In the short term, the use of the propensity to consume as a given factor conforms to the actual situation of the economy. In this way, due to χₜ+dₜ=1, it may be derived that the investment rate is also a given factor.

In the short term, on the assumption that the consumption demand factor aₜ (=cₜχₜ) that impacts the quantity of employment does not change, the general model of employment function may be rewritten as:

ΔNₜ^{w}=(aₜ+dₜkₜⁱ)Yₜ^{d} (8)

The equation (8) indicates that, in the short term, on the assumption that the employment multiplier of consumption cₜ, the propensity to consume χₜ and the investment rate dₜ do not change, the change in employment depends on the employment multiplier of investment and the effective demand. Even if the effective demand does not change, a greater employment multiplier of investment leads to greater employment.

### The Change in Employment Multiplier of Investment and the Direction of Change in Employment

1) When (aₜ+dₜkₜⁱ)>0, kₜⁱ>−(aₜ/dₜ), ΔNₜ^{w}>0, indicating that the quantity of employment increases as the effective demand increases when the change in employment multiplier of investment makes the employment multiplier (aₜ+dₜkₜⁱ) to be positive, the proportion depending on (aₜ+dₜkₜⁱ). In the N^{w}−Y^{d} model of supply-demand equilibrium, the supply-demand equilibrium curve extends to the upper right.

2) When (aₜ+dₜkₜⁱ)=0, kₜⁱ=−(aₜ/dₜ), ΔNₜ^{w}=0, indicating that the equilibrium employment does not change regardless of whether or not the effective demand of a country increases when the change in employment multiplier of investment exactly makes the employment multiplier (aₜ+dₜkₜⁱ) to be zero. In the N^{w}−Y^{d} model of supply-demand equilibrium, the supply-demand equilibrium curve extends upwards.

3) When (aₜ+dₜkₜⁱ)<0, kₜⁱ<−(aₜ/dₜ), ΔNₜ^{w}<0, indicating that the quantity of employment is negatively correlated to the effective demand when the decrease in employment multiplier of investment makes the employment multiplier (aₜ+dₜkₜⁱ) to be negative, the proportion depending on the absolute value of the employment multiplier of investment. In the N^{w}−Y^{d} model of supply-demand equilibrium, the supply-demand equilibrium curve extends to the upper left.

It is to be noted that the employment multiplier of investment may change rapidly in the short term, or even becomes negative, which is the most important factor that leads to the change in economic cycles.

### The Simplified Model of Employment Function and the Extension of the Supply-Demand Equilibrium Curve

As shown in FIG. 1, the solid line shows the supply-demand equilibrium curve and the dotted line shows the full employment curve. From the point in time t−1 to the point in time t, the change in employment is ΔNₜ^{w}=Nₜ^{w}−Nₜ₋₁^{w}, which is related to the simplified model of employment function ΔNₜ^{w}=kₜYₜ^{d}. The simplified model of employment function ΔNₜ^{w}=kₜYₜ^{d} preliminarily explains the factors that determine the extension of the supply-demand equilibrium curve.

First, the extension direction and magnitude of the supply-demand equilibrium curve at the point in time t determine the change in employment and are related to the employment multiplier kₜ and the effective demand Yₜ^{d}.

Then, the employment multiplier kₜ affects the slope of the supply-demand equilibrium curve at the point in time t, and reflects the impact of effective demand on employment. The extension direction of the supply-demand equilibrium curve depends on whether the employment multiplier is positive or negative, instead of the increase in effective demand (economic growth).

### The General Model of Employment Function and the Change in Employment Gap

At the point in time t, the difference between the equilibrium employment measured in the real wage-unit Nₜ^{w} and the full employment Nₜ^{w}* is defined as employment gap Nₜ^{wu}, i.e.:

Nₜ^{wu}=Nₜ^{w}*−Nₜ^{w} (9)

At the point in time t, it is defined that the full employment multiplier of potential output k*ₜ is equal to the ratio of the change in employment measured in the real wage-unit ΔNₜ^{w}* to the real potential output Yₜ^{p}, i.e.:

k*ₜ=ΔNₜ^{w}*/Yₜ^{p} (10)

The full employment multiplier of potential output may be abbreviated as full employment multiplier.

In the short term, it may be assumed that the slope of the full employment curve is a given positive value. In this way, the extension direction and magnitude of the supply-demand equilibrium curve of a country determine the change in employment gap of the country. As shown in FIG. 2, the employment gap of a country may change in the following several ways.

First, the employment gap shrinks. The basic characteristics of this state are described as follows: ΔNₜ^{w}>ΔNₜ^{w}*; in this case, the supply-demand equilibrium curve extends to the upper right, and the slope of the supply-demand equilibrium curve is greater than the slope of the full employment curve. This happens only when the relationship between the propensity to consume and the employment multiplier of investment makes the employment multiplier to be greater than the average full employment multiplier, i.e., (cₜχₜ+dₜkₜⁱ)>k̅ₜⁿ*. To increase (cₜχₜ+dₜkₜⁱ), it is necessary to increase the propensity to consume or increase the employment multiplier of investment.

Second, the employment gap disappears. The basic characteristics of this state are described as follows: Nₜ^{w}=Nₜ^{w}* and Yₜ^{p}=Yₜ*; in this case, there is no employment gap, nor output gap, and the supply-demand equilibrium curve and the full employment curve intersect at the point in time. The effective demand exactly corresponding to the full employment is a special case, and the employment gap becomes zero only when there is a special relationship between the propensity to consume and the employment multiplier of investment, i.e., (cₜχₜ+dₜkₜⁱ)=kₜ*.

Third, the employment gap does not change. The basic characteristics of this state are described as follows: ΔNₜ^{w}=ΔNₜ^{w}*; in this case, the supply-demand equilibrium curve N′ₜ^{y} extends to the upper right, and the slope of the supply-demand equilibrium curve is equal to the slope of the full employment curve. The employment gap of a country is approximately kept unchanged when the relationship between the propensity to consume and the employment multiplier of investment makes the employment multiplier to be equal to the average full employment multiplier, i.e., (cₜχₜ+dₜkₜⁱ)=k̅ₜⁿ*, and this actually reflects the employment stagnation.

Fourth, the employment gap expands. This state is relatively complex. Generally, it is manifested by following stages.

1) The employment gap begins to expand. The basic characteristics of this state are described as follows: ΔNₜ^{w}<ΔNₜ^{w}*; in this case, the supply-demand equilibrium curve N′ₜ^{y} extends to the upper right, and the slope of the supply-demand equilibrium curve is less than the slope of the full employment curve. The increase in effective demand of a country fails to shrink the employment gap although facilitating the increase in employment, when the relationship between the propensity to consume and the employment multiplier of investment makes the employment multiplier to be less than the average full employment multiplier, i.e., 0<(cₜχₜ+dₜkₜⁱ)<k̅ₜⁿ*.

2) The employment gap expands gradually. The basic characteristics of this state are described as follows: ΔNₜ^{w}=0; in this case, the supply-demand equilibrium curve extends upwards. The increase in equilibrium employment cannot be facilitated regardless of whether or not the effective demand of a country increases, when the relationship between the propensity to consume and the employment multiplier of investment makes the employment multiplier to be zero, i.e., (cₜχₜ+dₜkₜⁱ)=0.

3) The employment gap expands rapidly. The basic characteristics of this state are described as follows: ΔNₜ^{w}<0; in this case, the supply-demand equilibrium curve extends to the upper left. The quantity of employment decreases even if the effective demand of a country still increases, when the relationship between the propensity to consume and the employment multiplier of investment makes the employment multiplier to be negative, i.e., (cₜχₜ+dₜkₜⁱ)<0. Generally a too high negative employment multiplier of investment leads to negative employment multiplier; the pace of decrease in employment depends on (cₜχₜ+dₜkₜⁱ).

4) The employment gap expands sharply. The basic characteristics of this state are described as follows: ΔNₜ^{w}<0 and ΔYₜ^{d}<0; in this case, the supply-demand equilibrium curve N′″ₜ^{y} extends to the lower left. If the propensity to consume decreases and the negative employment multiplier of investment continuously increases, the decrease in effective demand may aggravate the decrease in employment, and in this case, both the employment gap and the output gap of a country are expanded. High unemployment rate, accompanied by decreased real wages, is caused. This is the so called unemployment crisis.

### BRIEF DESCRIPTION OF THE DRAWINGS

In order to explain technical solutions of embodiments of the present invention or in the prior art more clearly, the accompanying drawings to be used in the description of the embodiments or the prior art will be introduced briefly. Apparently, the drawings to be described below are merely some embodiments of the present invention, a person of ordinary skill in the art can obtain other drawings according to these drawings without paying any creative effort.

FIG. 1 is a schematic diagram showing the simplified model of employment function and the extension of the supply-demand equilibrium curve;

FIG. 2 is a schematic diagram showing the change in extension direction of the supply-demand equilibrium curve and the change in employment gap;

FIG. 3 is a schematic diagram showing the change in new employment of the United States from 2006 to 2014;

FIG. 4 is a schematic diagram showing the change in real GDP of the United States from 2006 to 2014;

FIG. 5 is a schematic diagram showing the quarterly employment multiplier of the United States from 2006 to 2014;

Fig, 6 is a schematic diagram showing the propensity to consume of the United States from 2006 to 2014;

FIG. 7 is a schematic diagram showing the investment rate of the United States from 2006 to 2014;

FIG. 8 is a schematic view of a system for economic aggregate analysis based on employment function, according to the present invention;

FIG. 9 is a schematic view of a processing portion;

FIG. 10 is a schematic view of an effective demand analysis module; and

FIG. 11 shows a supply-demand equilibrium curve analysis module.

### DETAILED DESCRIPTION OF THE PRESENT INVENTION

To make the purposes, technical solutions and advantages of the embodiments of the present invention clearer, the technical solutions in the embodiments of the present invention will be clearly and completely described below with reference to the accompanying drawings in the embodiments of the present invention.

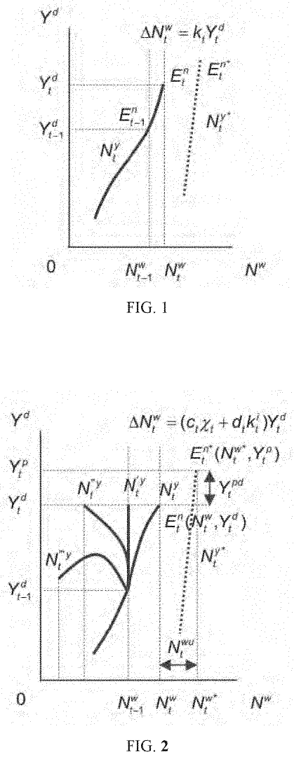

As shown in FIGS. 1-7, the unemployment crisis of the United States in 2007 will be discussed by the analysis method based on employment function according to the present invention. Data is collected from the Department of Commerce and the Department of Labor of the United States.

### The Change in Employment of the United States

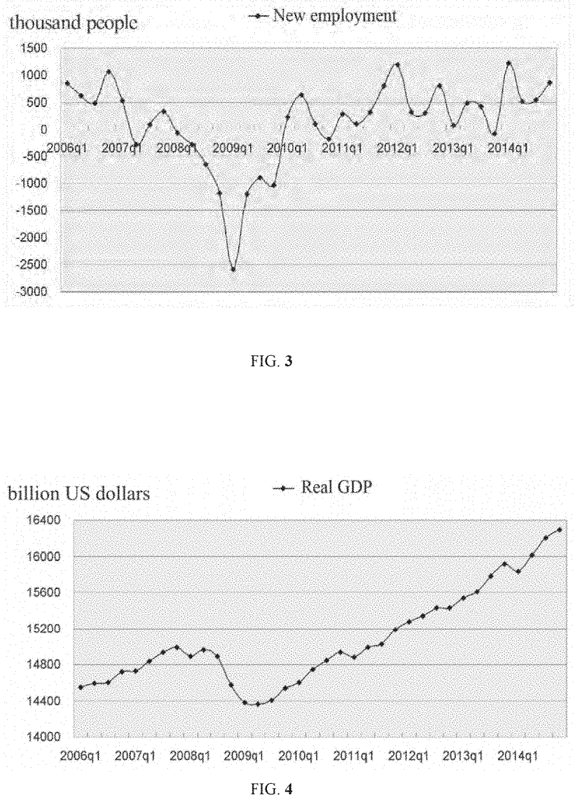

It may be found in FIG. 3 that the new employment of the United States decreased to negative for the first time from the second quarter of 2007 when compared to the first quarter; the employment was decreased by over 280,000 people, which showed that the economy had obvious characteristics of unemployment crisis. From the first quarter of 2008, the new employment of the United States became negative for eight consecutive quarters. Especially in the first quarter of 2009, the employment was decreased by over 2.59 million people, which indicated that the United. States has fallen into the severe unemployment crisis, in the second half of 2011, the employment indicator of the United States began to improve. However, in the second quarter of 2012, the increase in employment of the United States fell significantly. In the first quarter of 2013, there was merely a newly increase of more than 70,000 people employed. In the fourth quarter of 2013, the quantity of employment became negative, again, indicating that the United States has not shaken off the unemployment crisis.

### The Impact on Employment by the Growth of the Real GDP of the United States

With reference to FIG. 4, during the unemployment crisis of the United States from 2006 to 2008, the fall in real GDP growth of the United States was later than the decrease in employment. The decrease in employment has begun in the second quarter of 2007, in which the real GDP of the United States was still growing, audit wasn't until the first quarter of 2008 that the real GDP fell from the previous quarter. It was shown by economic data that the magnitude and duration of the fall in real GDP of the United States are both lower than those of the decrease in employment. From the first quarter of 2008 to the second quarter of 2009, the real GDP declined for sixth consecutive quarters, and from the first quarter of 2008 to the fourth quarter of 2009, the employment decreased for eight consecutive quarters. In the second half of 2011, the real GDP had basically returned to grow. However, the unemployment crisis still existed, and the change in employment cannot be maintained in positive within two consecutive quarters. It was indicated by the causal relationship that, since 2008, the fall in real GDP of the United States is not the cause of the decrease in employment, but the result of the decrease in employment.

### The Impact on Employment by the Structure of the Effective Demand of the United States

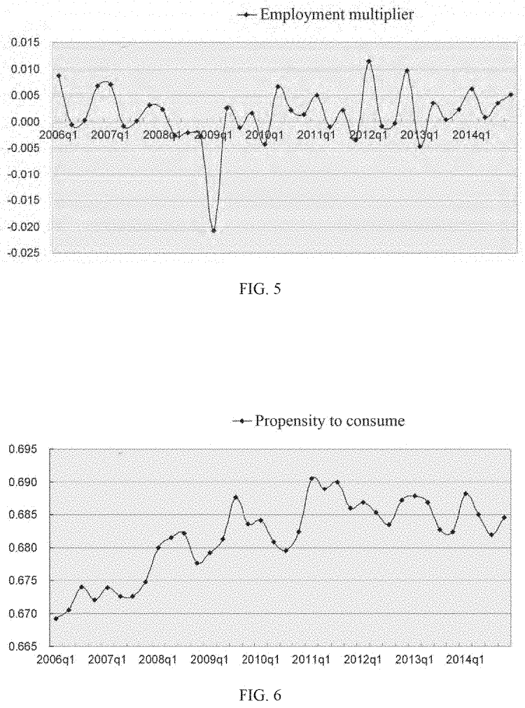

FIG. 5 is a schematic diagram showing the change in quarterly employment multiplier of the United States from 2006 to 2014. In the decade before 2007, the average full employment multiplier of the United States was k̅ₜⁿ*=0.012. In the first quarter of 2007, (cₜχₜ+dₜkₜⁱ)=0.009<k̅ₜⁿ*=0.012. When the employment multiplier, which is determined by both the propensity to consume and the employment multiplier of investment, is less than the average full employment multiplier, the employment rate of the United States decreases. Since then, the employment multiplier of the United States decreased continuously. In the second quarter of 2007, (cₜχₜ+dₜkₜⁱ)<0. When the employment multiplier, which is determined by both the propensity to consume and the employment multiplier of investment, is less than zero, the employment decreases regardless of whether or not the real GDP of the United States increases. In this case, it is difficult to increase the employment level even if the United States government facilitates the economic growth by macroeconomic policies. If it is unable to improve the overall employment status by the economic growth or even the economic growth negatively impacts the employment, attention should be paid to the impact on employment by the change in propensity to consume and employment multiplier of investment.

### The Impact on Employment by the Change in Propensity to Consume of the United States

FIG. 6 is a schematic diagram showing the trend of the change in quarterly propensity to consume of the United States from 2006 to 2014. As shown, from the first quarter of 2006 to the third quarter of 2009, the propensity to consume of the United States showed a trend of rising continuously. After one year of adjustment, in the first quarter of 2011, the proportion of U.S. personal consumption expenditure to total income has reached a maximum of 0.69. In the following years, the propensity to consume of the United States showed a trend of falling slowly. Overall, the trend of the change in quarterly propensity to consume of the United States is not consistent with the trend of the change in employment, indicating that the change in propensity to consume of the United States is not the cause of the unemployment crisis. This is because, from the first quarter of 2006 to the third quarter of 2008, the propensity to consume of the United States increased continuously, and such continuous rising did not lead to the reverse change in employment in the same period. Instead, such continuous rising in propensity to consume of the United States may, to some extent, cause inhibition to the decrease in (cₜχₜ+dₜkₜⁱ).

### The Impact on Employment by the Change in Employment Multiplier of Investment (and Investment Rate)

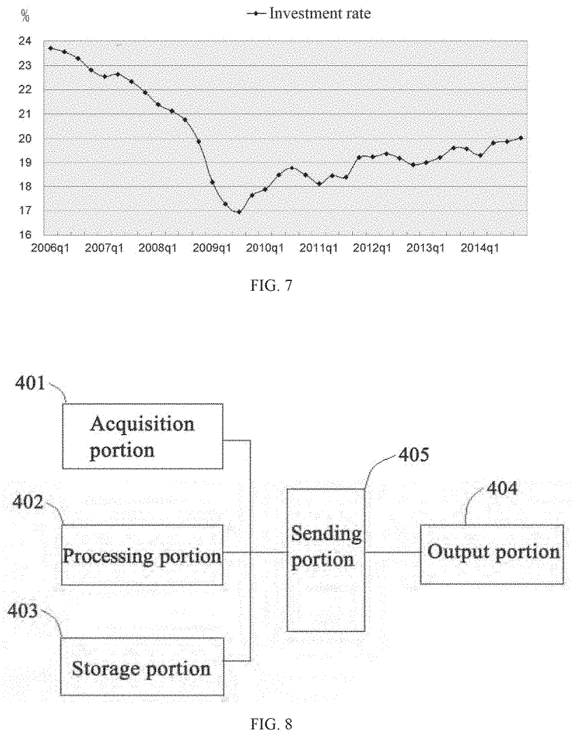

During the unemployment crisis, the impact on employment by the change in investment rate should be taken into consideration. FIG. 7 is a schematic diagram showing the quarterly data of the investment rate of the United States from 2006 to 2014. In summary, before the unemployment crisis, the investment rate of the United States decreased continuously; and after the unemployment crisis, the investment rate recovered slowly.

First, it is necessary to explain the relationship between the investment rate and the propensity to consume. Generally, the continuous rising in propensity to consume inevitably causes the decrease in investment rate. If the employment multiplier of investment does not increase, the impact on employment by the decrease in investment rate cannot be offset by the increase in propensity to consume of the United States. As a result, the employment multiplier (cₜχₜ+dₜkₜⁱ) of the United States decreases.

Then, it is necessary to explain the impact on employment by the decrease in investment rate. In any condition, the investment rate and the propensity to consume are greater than zero. Therefore, the decrease in investment rate could not lead to a negative (cₜχₜ+dₜkₜⁱ). Since the decrease in investment rate could not cause the impact on employment by investment to be negative, (cₜχₜ+dₜkₜⁱ) may be negative only when the employment multiplier of investment sharply decreases to be negative.

Finally, although the United States has no data of employment multiplier of investment, it may be known by logical analysis that, inevitably, during the unemployment crisis, the employment multiplier of investment of the United States significantly decreased to be negative. The decrease in investment rate is one of causes, but not the main cause, of the unemployment crisis of the United States. Given the continuous decrease in saving rate and investment rate of the United States, the continuous and significant decrease in employment multiplier of investment leads to negative (cₜχₜ+dₜkₜⁱ), which causes the quantity of employment of the United States to decrease continuously. Consequently, the United States falls into the unemployment crisis, inevitably.

The preliminary cause of the unemployment crisis of the United States: low inducement to invest.

Generally, if the inducement to invest of a country is low, the employment multiplier of investment may change dramatically in the short term, or even become negative rapidly. The low inducement to invest of the United States is reflected by the rapid decrease of the employment multiplier of investment to be negative When the investment rate decreases. Thus, the employment multiplier (cₜχₜ+dₜkₜⁱ) sharply decreases to be negative. In this case, the unemployment crisis is inevitable even if the real GDP of the United States grows stably and the propensity to consume increases continuously.

As shown in FIG. 8, the present invention provides a system for economic aggregate analysis based on employment function, comprising:

an acquisition portion 401, configured to obtain quarterly or monthly raw macroeconomic data of a country (region), including data of GDP, employment, price index, wage, volume of consumption, volume of investment, etc., wherein, the acquisition portion comprises a server provided by a data service provider, a database connection tool, an external storage device or a manual input device; and

a processing portion 402, configured to calculate the indicators of a quarterly or monthly employment function of the country (region) according to the quarterly or monthly raw macroeconomic data of the country (region), and carry out short-term economic analysis by the indicators, wherein, the processing portion comprises one or more central processing units (CPUs) or other specific processors.

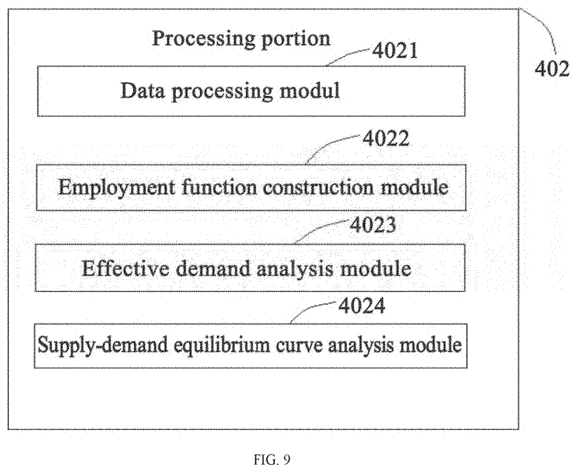

As show in FIG. 9, the processing portion 402 specifically comprises:

a data processing module 4021, configured to establish time series of macroeconomic data of a quarterly or monthly employment function model of a country (region) by the acquisition portion, including new employment, real GDP, propensity to consume, investment rate, etc., observe and preliminarily analyze the trend of change in economic variables and the mutual impact of the economic variables;

an employment function construction module 4022, configured to construct a quarterly or monthly employment function model of a country (region) in a period according to the data processing module;

an effective demand analysis module 4023, configured to analyze the impact on employment by the quantity and structure of the quarterly or monthly effective demand of a country (region) in a period according to the employment function construction module; and

a supply-demand equilibrium curve analysis module 4024, configured to analyze the change in a quarterly or monthly supply-demand equilibrium curve of a country (region) in a period according to the employment function construction module.

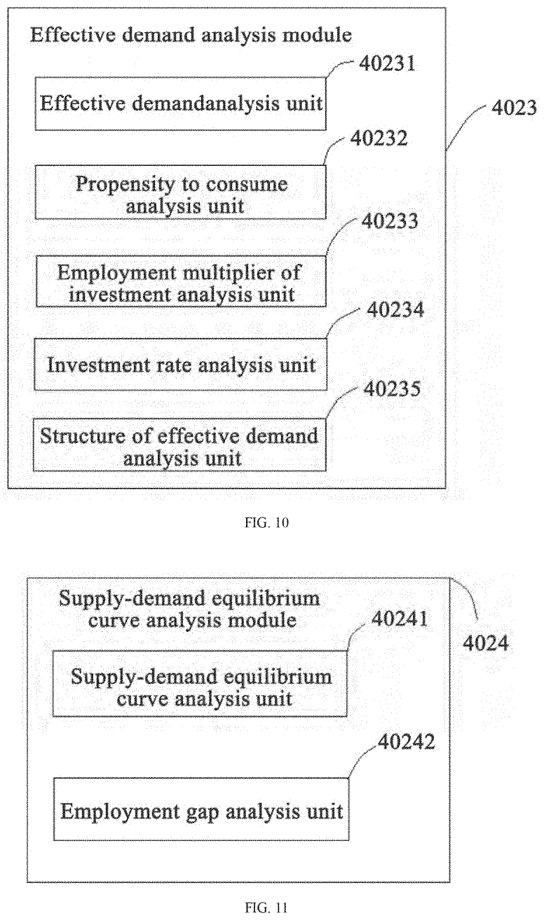

As shown in FIG. 10, the effective demand analysis module 4023 specifically comprises:

an effective demand analysis unit 40231, configured to analyze the impact on employment by the quarterly or monthly effective demand of a country (region) in a period;

a propensity to consume analysis unit 40232; configured to analyze the impact on employment by the quarterly or monthly propensity to consume of a country (region) in a period and how the marginal propensity to consume impacts the change in employment;

an employment multiplier of investment analysis unit 40233, configured to analyze the impact on the quantity and change direction of employment by the quarterly or monthly employment multiplier of investment of a country (region) in a period;

an investment rate analysis unit 40234, configured to analyze the impact on employment by the quarterly or monthly investment rate of a country (region) in a period; and

a structure of effective demand analysis unit 40235, configured to comprehensively analyze the impact on the quantity and change direction of employment by the structure of the quarterly or monthly effective demand of a country (region) in a period according to the effective demand analysis unit, the propensity to consume analysis unit, the employment multiplier of investment analysis unit and the investment rate analysis unit.

As shown in FIG. 11, the supply-demand equilibrium curve analysis module 4024 specifically comprises:

a supply-demand equilibrium curve analysis unit 40241, configured to analyze the extension direction and magnitude of a quarterly or monthly supply-demand equilibrium curve of a country (region) in a period according to the employment function construction module; and

an employment gap analysis unit 40242, configured to the analyze the change in quarterly or monthly employment gap of a country (region) in a period according to the employment function construction module.

Government departments, institutions or enterprises may separately implement the above-described embodiments according to different needs, or may select all or part of the quarterly or monthly economic analysis methods separately, or combine these embodiments in different implementations.

Preferably, the system further includes a storage portion 403 configured to store the raw macroeconomic data and the processed data, the employment function model and the analysis results from the analysis modules. The storage portion may include one or more readable storage media, such as floppy disks of computers, USB flash disks, mobile hard disks, read-only memories (ROMs), random access memories (RAMs), disks or CDs. Further, the central processing units may be configured to communicate with the storage media to execute, on the system, a series of instructions stored in the storage media.

Preferably, the system further includes an output portion 404 configured to output the employment function model and the analysis results from the analysis modules. The output portion is specifically a display screen or a printing device.

Preferably, the system further includes a sending portion 405 configured to send the employment function model and the analysis results from the analysis modules to a terminal. The sending portion is specifically a Bluetooth unit or a WIFI wireless network transmission unit or a wired network transmission unit or a 2.5G, 3G, 4G or 5G transmission unit.

The system may further include one or more wired or wireless network interfaces, one or more input/output interfaces, and one or more operating systems such as Windows Server™, Mac OS X™, Unix™, Linux™, FreeBSD™.

Through the description of the above embodiments, those skilled in the art can clearly understand that the present invention can be implemented by means of software and necessary general hardware, and of course, dedicated hardware including application-specific integrated circuits, dedicated CPUs, dedicated memories, specific components may be adopted to achieved to implement the present invention. In general, functions performed by computer programs can be easily implemented with corresponding hardware, and the specific hardware structure used to implement the same function can be various, such as analog circuits, digital circuits, and dedicated circuits. However, for the present invention, implementation by software programs is preferred. Based on this, the part of the technical solution of the present invention, which is essential or contributes to the prior art, can be embodied in the form of software products stored in readable storage media such as floppy disks of computers, USB flash disks, mobile hard disks, read-only memories (ROMs), random access memories (RAMs), disks or CDs, including instructions to enable a computer device (a personal computer, a server, or a network device, etc.) to perform the method described in the embodiments of the present invention.

The method of the present invention establishes an economic analysis method for unifying the product market and the labor market by constructing employment function model. For a long time, the macroeconomic model ignores the key variable: employment, and thus is unable to appropriately combine the product market from the labor market. The method of the present invention effectively solves this problem. The employment function indicates the relationship between the effective demand and the employment of an economy in a certain period. By linking the main economic aggregate indicators such as price index, wage, propensity to consume and volume of investment, the employment function shows the overall economic status and the development trend of the economy in this period. The employment function model is generally applicable to short-term economic analysis of various economies. By analyzing the impact on employment by the quantity and structure of effective demand, main factors that influence the short-term economic change or even the direction of change can be found. This method may be also used to explain the extension of the supply-demand equilibrium curve. The combination of the algebraic analysis method and the graphic analysis method is more convenient to observe the short-term economic change, and especially useful in tracking the evolution process of the unemployment crisis. Thus, the method and system of the present invention can effectively analyze the change in relationship between the main macroeconomic indicators of an economy, provide a policy basis for governments to timely protect against and response to economic crisis, and provide effective technical support for economic analysis, economic forecasting and production decision-making of various industries and organizations. It has been proven that the existing macroeconomic model is unable to predict economic crisis accurately, even unable to effectively provide response to economic crisis.

For the system disclosed in the embodiment, since it corresponds to the method disclosed in the embodiment, the description of the system is relatively simple and the relevant parts can be referred to the description of the method.

The foregoing descriptions are only specific implementations of the present invention. The protection scope of the present invention is not limited thereto. A person of ordinary skill in the art can readily think of equivalent replacements or changes within the technical scope disclosed in the present invention, and those replacements or changes should be within the protection scope of the present invention.

What is claimed is:

1. A method for economic aggregate analysis based on employment function, comprising steps of:
using employment measured in the real wage-unit in an economy, the employment measured in the real wage-unit at a point in time t being defined by:
Nₜ^{w}=Nₜ·W̅ₜ (1)
wherein the equation shows that, at each point in time t, the employment measured in the real wage-unit Nₜ^{w} is equal to the product of employment Nₜ and the real average wage W̅ₜ at the point in time, and equal to the real gross wage of a country;
constructing a simplified model of employment function from the employment multiplier equation of effective demand according to the Keynes's model Nᵣ=Fᵣ(D_{w}):
ΔNₜ^{w}=kₜ^{Y}ₜ^{d} (3)
where ΔNₜ^{w} is the change in employment, kₜ is the employment multiplier, and Yₜ^{d} is the real effective demand;
wherein, the basic characteristics of the simplified model of employment function are described as follows: first, this model indicates that the change in employment ΔNₜ^{w} is positively correlated to the effective demand Yₜ^{d} and the employment multiplier kₜ; and then, the employment multiplier may be positive, or zero, or even negative; 1) when kₜ>0, ΔNₜ^{w}>0, indicating that the quantity of employment increases as the effective demand increases only when the employment multiplier is positive; 2) when kₜ=0, ΔNₜ^{w}=0, indicating that the quality of employment does not change regardless of whether or not the effective demand increases if the employment multiplier is zero; and 3) when kₜ<0, ΔNₜ^{w}<0, indicating that the quantity of employment decreases even if the effective demand increases if the employment multiplier is negative;
obtaining a theoretical model of employment function from a short-term determining equation of employment multiplier:
ΔNₜ^{w}=(cₜχₜ+bₜδₜ)Yₜ^{d} (5)
wherein this equation indicates that, in the short term, the change in employment depends on the effective demand Yₜ^{d} and also on a relationship between the propensity to consume χₜ and the investment rate δₜ on the assumption that the employment multiplier of consumption cₜ and the employment multiplier of investment bₜ are constant;
obtaining a more general form of employment function from a general form of the determining equation of employment multiplier on the assumption that the employment multiplier of consumption cₜ and the investment rate dₜ are constant:
ΔNₜ^{w}=(cₜχₜ+dₜkₜⁱ)Yₜ^{d} (7)
wherein, the basic characteristics of the general form of employment function are described as follows: first, although the effective demand is positively correlated to the quantity of employment, the impact on the quantity of employment by the change in effective demand depends, to some extent, on the relative change in the propensity to consume and the employment multiplier of investment; second, the propensity to consume is positively correlated to the quantity of employment; third, the employment multiplier of investment is positively correlated to the quantity of employment; fourth, the relationship between the propensity to consume χₜ and the employment multiplier of investment kₜⁱ has an impact on the quantity of employment and also determines the direction of the change in employment; 1) when (cₜχₜ+dₜkₜⁱ)>0, ΔNₜ^{w}>0, indicating that the quantity of employment increases as the effective demand increases only when kₜⁱ>−(cₜ/dₜ)χₜ; 2) when (cₜχₜ+dₜkₜⁱ)=0, ΔNₜ^{w}=0, indicating that the quantity of employment does not change regardless of whether or not the effective demand increases if kₜⁱ=−(cₜ/dₜ)χₜ; and 3) when (cₜχₜ+dₜkₜⁱ)<0, ΔNₜ^{w}<0, indicating that the quantity of employment decreases even if the effective demand increases if kₜⁱ<−(cₜ/dₜ)χₜ; fifth, the change in the relationship between the propensity to consume and the employment multiplier of investment may lead to insufficiency of effective demand in the society; it is important to note that, if the employment multiplier of investment is negative, the expansion of investment will cause inhibition to employment;
analyzing the change in employment gap by using the general model of employment function,
wherein, in the short term, on the assumption that the slope of a full employment curve is a given positive, the employment gap of a country may change in the following several ways:
first, the employment gap shrinks, and the basic characteristics of this state are described as follows: ΔNₜ^{w}>ΔNₜ^{w}*; this happens only when the relationship between the propensity to consume and the employment multiplier of investment makes the employment multiplier to be greater than the average full employment multiplier, i.e., (cₜχₜ+dₜkₜⁱ)>k̅ₜⁿ*;
second, the employment gap disappears, and the basic characteristics of this state are described as follows: Nₜ^{w}=Nₜ^{w}* and Yₜ^{p}=Yₜ*; the effective demand exactly corresponding to the full employment is a special case, and the employment gap becomes zero only when there is a special relationship between the propensity to consume and the employment multiplier of investment, i.e., (cₜχₜ+dₜkₜⁱ)=kₜ*;
third, the employment gap does not change, and the basic characteristics of this state are described as follows: ΔNₜ^{w}=ΔNₜ^{w}*; the employment gap of a country is approximately kept unchanged when the relationship between the propensity to consume and the employment multiplier of investment makes the employment multiplier to be equal to the average full employment multiplier, i.e., (cₜχₜ+dₜkₜⁱ)=k̅ₜⁿ*, and this actually reflects the employment stagnation; and
fourth, the employment gap expands, manifested by following stages:
1) the employment gap begins to expand, and the basic characteristics of this state are described as follows: ΔNₜ^{w}<ΔNₜ^{w}*; the increase in effective demand of a country fails to shrink the employment gap although facilitating the increase in employment, when the relationship between the propensity to consume and the employment multiplier of investment makes the employment multiplier to be less than the average full employment multiplier, i.e., 0<(cₜχₜ+dₜkₜⁱ)<k̅ₜⁿ*;
2) the employment gap expands gradually, and the basic characteristics of this state are described as follows: ΔNₜ^{w}=0; the increase in employment cannot be facilitated regardless of whether or not the effective demand of a country increases, when the relationship between the propensity to consume and the employment multiplier of investment makes the employment multiplier to be zero, i.e., (cₜχₜ+dₜkₜⁱ)=0;
3) the employment gap expands rapidly, and the basic characteristics of this state are described as follows: ΔNₜ^{w}<0; the quantity of employment decreases even if the effective demand of a country still increases, when the relationship between the propensity to consume and the employment multiplier of investment makes the employment multiplier to be negative, i.e., (cₜχₜ+dₜkₜⁱ)<0; generally, a too high negative employment multiplier of investment leads to negative employment multiplier; and
4) the employment gap expands sharply, and the basic characteristics of this state are described as follows: ΔNₜ^{w}<0 and ΔYₜ^{d}<0; if the propensity to consume decreases and the negative employment multiplier of investment continuously increases, the decrease in effective demand may aggravate the decrease in employment, and in this case, both the employment gap and the output gap of a country are expanded.

2. The method for economic aggregate analysis based on employment function according to claim 1, wherein the general model of employment function reflects the relationship between the propensity to consume and the quantity of employment:
according to the equation (7), if the propensity to consume approaches 1, then ΔNₜ^{w}≈cₜYₜ^{d}, the impact on the equilibrium employment by investment factors can be ignored; and in the short term, on the assumption that the employment multiplier of consumption cₜ is a constant, the equilibrium employment depends on the effective demand; and
in the long term, the equilibrium employment first depends on the propensity to consume; and in the short term, the marginal propensity to consume is an important factor that impacts the change in employment, and the quantity of employment usually increases as the propensity to consume increases; and since the marginal propensity to consume decreases progressively, it is difficult to maintain the increase in employment in the long term by increasing the effective demand by the continuous expansion of investment.

3. The method for economic aggregate analysis based on employment function according to claim 1, wherein the general model of employment function reflects the relationship between the employment multiplier of investment and the quantity of employment:
in the short term, on the assumption that the consumption demand factor aₜ (=cₜχₜ) that impacts the quantity of employment does not change, the general model of employment function may be rewritten as:
ΔNₜ^{w}=(aₜ+dₜkₜⁱ)Yₜ^{d} (8)
the equation (8) indicates that, in the short term, on the assumption that the employment multiplier of consumption cₜ, the propensity to consume χₜ and the investment rate dₜ do not change, the change in employment depends on the employment multiplier of investment and the effective demand;
1) when (aₜ+dₜkₜⁱ)>0, kₜⁱ>−(aₜ/dₜ), ΔNₜ^{w}>0, in which case, the quantity of employment increases as the effective demand increases, the proportion depending on (aₜ+dₜkₜⁱ);
2) when (aₜ+dₜkₜⁱ)=0, kₜⁱ=−(aₜ/dₜ), ΔNₜ^{w}=0, in which case, the equilibrium employment does not change regardless of whether or not the effective demand of a country increases;
3) when (aₜ+dₜkₜⁱ)<0, kₜⁱ<−(aₜ/dₜ), ΔNₜ^{w}<0, in which case the quantity of employment is negatively correlated to the effective demand, the proportion depending on the absolute value of the employment multiplier of investment;
it is to be noted that the employment multiplier of investment may change rapidly in the short term, or even becomes negative, which is the most important factor that leads to the change in economic cycles.

4. The method for economic aggregate analysis based on employment function according to claim 1, wherein the simplified model of employment function has the following relationship with the extension of a supply-demand equilibrium curve:
first, the extension direction and magnitude of the supply-demand equilibrium curve at the point in time t are correlated to the employment multiplier kₜ and the effective demand Yₜ^{d}; and
second, the employment multiplier influences the magnitude of the supply-demand equilibrium curve at the point in time t, and the extension direction of the supply-demand equilibrium curve depends on the sign of the employment multiplier, instead of the increase in effective demand.

5. A system for economic aggregate analysis based on employment function, comprising:
an acquisition portion 401, configured to obtain quarterly or monthly raw macroeconomic data of a country (region), including data of GDP, employment, price index, wage, volume of consumption, volume of investment, etc., wherein, the acquisition portion comprises a server provided by a data service provider, a database connection tool, an external storage device or a manual input device;
a processing portion 402, configured to calculate a quarterly or monthly employment function indicator of the country (region) according to the quarterly or monthly raw macroeconomic data of the country (region), and carry out short-term economic analysis by the indicator, wherein, the processing portion comprises one or more central processing units (CPUs) or other specific processors;
a storage portion 403, configured to store the raw macroeconomic data and the processed data, the employment function model and the analysis results from the analysis modules, wherein, the storage portion may include one or more readable storage media;
an output portion 404, configured to output the employment function model and the analysis results from the analysis modules, wherein, the output portion is specifically a display screen or a printing device; and
a sending portion 405, configured to send the employment function model and the analysis results from the analysis modules to a terminal.

6. The system for economic aggregate analysis based on employment function according to claim 5, wherein the processing portion comprises:
a data processing module, configured to establish time series of macroeconomic data of a quarterly or monthly employment function model of a country (region) by the acquisition portion, including new employment, real GDP, propensity to consume, investment rate, etc., observe and preliminarily analyze the trend of change in economic variables and the mutual impact of the economic variables;
an employment function construction module, configured to construct a quarterly or monthly employment function model of a country (region) in a period according to the data processing module;
an effective demand analysis module, configured to analyze the impact on employment by the quantity and structure of the quarterly or monthly effective demand of a country (region) in a period according to the employment function construction module; and
a supply-demand equilibrium curve analysis module, configured to analyze the change in a quarterly or monthly supply-demand equilibrium curve of a country (region) in a period according to the employment function construction module.

7. The system for economic aggregate analysis based on employment function according to claim 6, wherein the effective demand analysis module comprises:
an effective demand analysis unit, configured to analyze the impact on employment by the quarterly or monthly effective demand of a country (region) in a period;
a propensity to consume analysis unit, configured to analyze the impact on employment by the quarterly or monthly propensity to consume of a country (region) in a period and how the marginal propensity to consume impacts the change in employment;
an employment multiplier of investment analysis unit, configured to analyze the impact on the quantity and change direction of employment by the quarterly or monthly employment multiplier of investment of a country (region) in a period;
an investment rate analysis unit, configured to analyze the impact on employment by the quarterly or monthly investment rate of a country (region) in a period; and
a structure of effective demand analysis unit, configured to comprehensively analyze the impact on the quantity and change direction of employment by the structure of the quarterly or monthly effective demand of a country (region) in a period according to the effective demand analysis unit, the propensity to consume analysis unit, the employment multiplier of investment analysis unit and the investment rate analysis unit.

8. The system for economic aggregate analysis based on employment function according to claim 6, wherein the supply-demand equilibrium curve analysis module comprises:
a supply-demand equilibrium curve analysis unit, configured to analyze the extension direction and magnitude of a quarterly or monthly supply-demand equilibrium curve of a country (region) in a period according to the employment function construction module; and
an employment gap analysis unit, configured to the analyze the change in quarterly or monthly employment gap of a country (region) in a period according to the employment function construction module.
